(19) United States
(12) Patent Application Publication
(10) Pub. No.: US 2025/0371396 A1
(43) Pub. Date: Dec. 4, 2025

(54) A CONTROLLER FOR A TRAPPED ION SYSTEM

(71) Applicant: Oxford Ionics Limited, Begbroke (GB)

(72) Inventors: Ana SOTIROVA, Oxford (GB); Maciej MALINOWSKI, Obergengstringen (CH); David Thomas Charles ALLCOCK, Eugene, OR (US)

(21) Appl. No.: 18/676,922

(22) Filed: May 29, 2024

(51) Int. Cl. G06N 10/40

(52) U.S. Cl. CPC G06N 10/40

(57) ABSTRACT

A controller (100) for a trapped ion system (110) for confining an ion (115), the controller (100) configured to: generate a control signal(S), the control signal(S) configured to confine the ion (115) in the trapped ion system (110); the control signal(S) comprising a plurality of frequency components, wherein at least one of the plurality of frequency components adjusts a frequency shift of the ion (115).

The present disclosure relates to a controller for confining an ion in a trapped ion system. In particular, it relates to a controller for confining an ion in a trapped ion system for quantum computing.

### BACKGROUND

A controller for confining an ion in a trapped ion system uses a control signal to confine the ion. Confinement in this context relates to confinement in three-dimensional space. Generally, for quantum computing purposes, the control signal is a radio frequency (RF) control signal comprising a single tone (a single frequency component) which is used for confinement of the ion.

The RF control signal, however, can introduce unwanted effects to the quantum computing system. The RF control signal can confine the ion in three-dimensional space, it can also alter the atomic structure of the ion being confined. The ion in the trapped ion system may experience a frequency shift due to the RF control signal, which can lead to gate errors.

### BRIEF SUMMARY

It is desirable to provide an improved controller for confining an ion in a trapped ion system for use in quantum computing.

According to a first aspect of the disclosure there is provided a controller for a trapped ion system, the controller configured to: generate a control signal, the control signal configured to confine an ion in the trapped ion system; the control signal comprising a plurality of frequency components, wherein at least one of the plurality of frequency components adjusts a frequency shift of the ion.

Optionally, the ion is a barium ion.

Optionally, the barium ion is an odd numbered isotope.

Optionally, the barium ion is ¹³⁷Ba⁺.

Optionally, the ion is configured as a unit of information for quantum computing.

Optionally, the unit of information for quantum computing is a qubit or a qudit.

Optionally, the control signal is an analog signal or a digital signal.

Optionally, the controller comprises a resonator, configured to modify the control signal.

Optionally, the resonator is a radio frequency resonator such that the control signal modified is a radio frequency control signal.

Optionally, the plurality of frequency components comprise at least a first frequency and a second frequency.

Optionally, the first frequency is configured to confine the ion in the trapped ion system.

Optionally, the second frequency is configured to adjust the frequency shift of the ion.

Optionally, the second frequency comprises a magnitude, the magnitude being tuned to adjust for the frequency shift of the ion.

Optionally, the second frequency adjusts the frequency shift of the ion by minimising the frequency shift of the ion.

Optionally, the frequency shift of the ion is an AC Zeeman shift of the ion.

Optionally, the first frequency is lower than the second frequency.

Optionally, the first frequency and the second frequency have a value greater than a secular frequency and lower than a limiting frequency.

Optionally, the secular frequency has a value of 20 megahertz and the limiting frequency has a value of 200 megahertz.

Optionally, the control signal is a radio frequency control signal and the plurality of frequency components are a plurality of radio frequency tones.

Optionally, the at least one of the plurality of frequency components adjust the frequency shift of the ion by minimising the frequency shift.

Optionally, the frequency shift of the ion is an AC Zeeman shift.

Optionally, the trapped ion system is a Paul trap.

Optionally, the trapped ion system comprises an ion trap.

Optionally, the ion trap is configured to receive the trap such that the ion is confined within the ion trap.

Optionally, trapped ion system comprises a vacuum chamber, the ion trap being within the vacuum chamber.

Optionally, the trapped ion system comprises an ion source configured to provide an ion to the ion trap.

Optionally, the ion source comprises: a neutral atom source configured to provide an atom; an ionisation device configured to ionise the atom, thereby providing the ion.

Optionally, the trapped ion system comprises: one or more DC electrodes configured to provide a static voltage to the trapped ion system; and one or more RF electrodes configured to provide an oscillating voltage to the trapped ion system.

Optionally, the trapped ion system comprises a magnetic field source configured to provide a magnetic field to the ion trap.

According to a second aspect of the present disclosure, there is provided an apparatus comprising: a trapped ion system for confining an ion; and a controller for the trapped ion system, the controller configured to generate a control signal;

the control signal configured to confine the ion in the trapped ion system, the control signal comprising a plurality of frequency components, wherein at least one of the plurality of frequency components adjusts a frequency shift of the ion.

Optionally, the ion is configured as a unit of information for quantum computing.

Optionally, the unit of information for quantum computing is a qubit or a qudit.

Optionally, the controller comprises a resonator, configured to generate the control signal.

Optionally, the resonator is a radio frequency resonator such that the control signal generated is a radio frequency control signal.

Optionally, the plurality of frequency components comprise at least a first frequency and a second frequency.

Optionally, the first frequency is configured to confine the ion in the ion trap and the second frequency is configured to adjust the frequency shift of the ion.

Optionally, the second frequency minimises the frequency shift of the ion.

Optionally, the frequency shift of the ion is an AC Zeeman Shift.

Optionally, the apparatus is a quantum computer.

It will be appreciated that the apparatus of the second aspect may include providing and/or using features set out in the first aspect and can incorporate other features as described herein.

According to a third aspect of the present disclosure, there is provided a method of confining an ion in a trapped ion system, the method comprising: generating, using a controller, a control signal, the control signal configured to confine the ion in the trapped ion system; the control signal comprising a plurality of frequency components, wherein at least one of the plurality of frequency components adjusts the frequency shift of the ion.

It will be appreciated that the method of the third aspect may include providing and/or using features set out in the first aspect and/or the second aspect and can incorporate other features as described herein.

### BRIEF DESCRIPTION OF THE DRAWINGS

The disclosure is described in further detail below by way of example only with reference to the accompanying drawings, in which:

FIG. 1(a) is a diagram of an energy structure of an ion; FIG. 1(b) is a diagram showing a frequency shift in the energy structure of the ion; FIG. 1(c) is a diagram showing the AC Zeeman shift of a qubit state |0> due to off-resonant coupling to the state |i>; FIG. 1(d) is a plot from a simulation showing the frequency shifts for a ¹³⁷Ba⁺ ion encoded as a qubit with F=2, m_{F}=−2 and F=3, mp=−2 pair of states in the D_{5/2} level as a function of the frequency of an oscillating magnetic field; and FIG. 1(e) is a plot from an analogous simulation showing the frequency shifts for a ¹³⁷Ba⁺ ion encoded as a qubit with F=2, m_{F}=0 and F=3, m_{F}=0 pair of states in the D_{5/2} level;

FIG. 2 is an example diagram of a controller for a trapped ion system for confining an ion according to the present disclosure;

FIG. 3 is another example diagram of a controller for a trapped ion system for confining an ion according to the present disclosure;

FIG. 4 is an example diagram of a control signal comprising a plurality of frequency components generated by the controller of either FIG. 2 or FIG. 3;

FIG. 5(a) is a table showing the frequency components for a control signal which adjust a frequency shift of a ¹³⁷Ba⁺ ion encoded as a qubit with F=2, m_{F}=−2 and F=3, m_{F}=−2 pair of states in the D_{5/2} level; and FIG. 5(b) is a table showing the frequency components for a control signal which adjust a frequency shift of a ¹³⁷Ba⁺ ion encoded as a qubit with F=2, m_{F}=0 and F=3, m_{F}=0 pair of states in the D_{5/2} level;

FIG. 6(a) is a plot showing the reduction of the frequency shift for the ¹³⁷Ba⁺ ion encoded as a qubit with F=2, m_{F}=−2 and F=3, m_{F}=−2 pair of states in the D_{5/2} level; and FIG. 6(b) is a plot showing the reduction of the frequency shift for the ¹³⁷Ba⁺ ion encoded as a qubit with F=2, m_{F}=0 and F=3, mp=0 pair of states in the D_{5/2} level;

FIG. 7 is an example embodiment of a trapped ion system according to the present disclosure;

FIG. 8 is an exemplary embodiment of a controller for confining an ion and adjusting a frequency shift according to the present disclosure;

FIG. 9 is an example diagram of an apparatus comprising a controller for a trapped ion system for confining an ion according to the present disclosure; and

FIG. 10 is an example of a method for confining an ion in a trapped ion system according to the present disclosure.

### DETAILED DESCRIPTION

Trapped ion systems for quantum computing purposes, in general, comprise of an ion trap in a vacuum chamber, a voltage source coupled to the ion trap, a source of neutral atoms, a source of static magnetic field, a plurality of lasers and a fluorescence detector. The plurality of lasers serve a number of purposes, including the excitation and photoionisation of the neutral atoms into ions and the cooling of the ions in the ion trap.

The trapped ion system as described could be, for example, a Paul-type trap. Paul-type traps require both a static direct current (DC) field and an oscillating radio frequency (RF) field to ensure that an ion in the trapped ion system is confined in the ion trap. In the context of the present disclosure, confinement is taken to mean the confinement of the ion in all three spatial directions.

The static DC field is generated by applying DC voltages to DC electrodes whilst the oscillating RF field is generated by applying an oscillating RF voltage to a RF electrode. The oscillating RF voltage may also be referred to as a trap RF voltage and is set through a control signal. Typically the control signal is a RF control signal comprising a single frequency component which is used for confinement of the ion. Both the DC electrodes and the RF electrodes are located on the ion trap of the trapped ion system. When the oscillating RF voltage is applied to the RF electrode, an oscillating current is generated. This oscillating current leads to an oscillating magnetic field at the ion position.

The electrons in an ion can only have particular, discrete energy values. These are referred to as the energy levels of an ion. The ion also has associated with it a frequency which may be referred to as an ion frequency. The ion frequency is defined as the frequency of radiation corresponding to the transition between two levels of the ion. For example, for an ion with two energy levels with energy values E₀ and E₁ where E₀ is of lesser value than E₁, the ion frequency will be f=E/h where E=E₁−E₀ and h is Planck's constant.

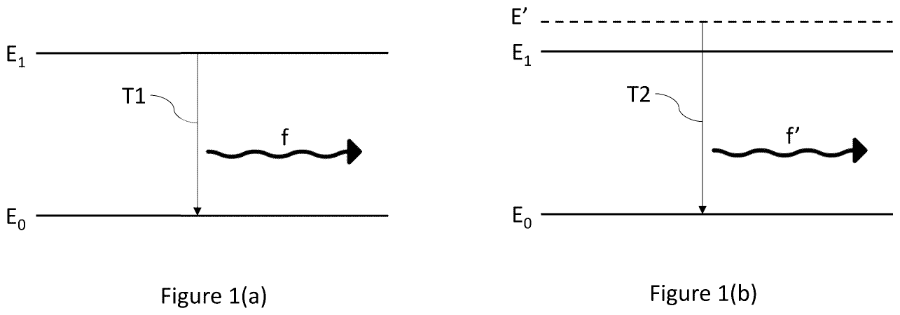

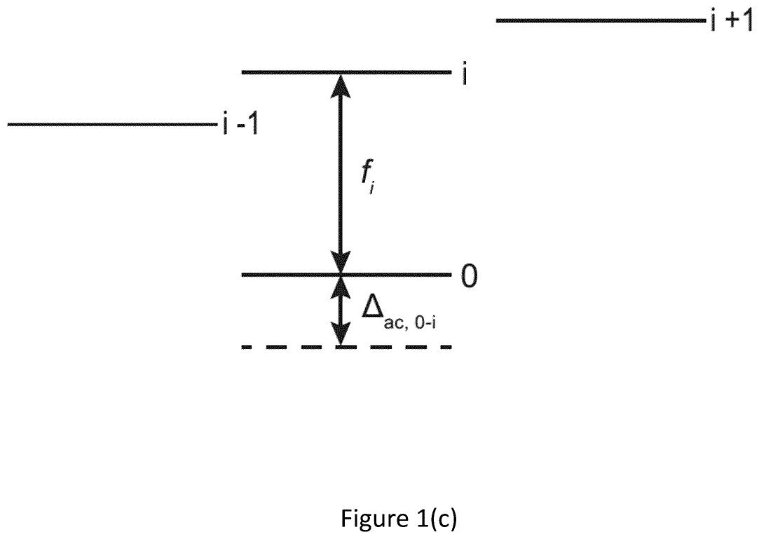

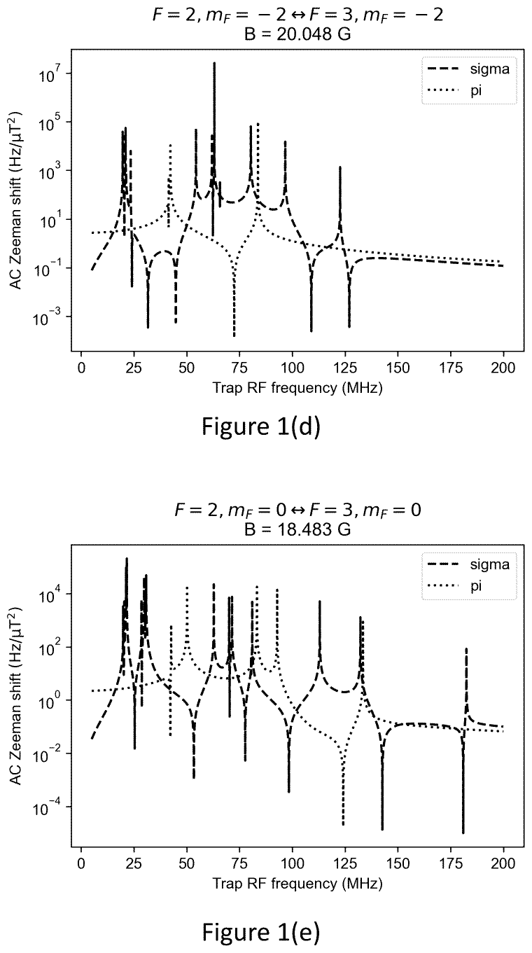

FIG. 1(a) shows the energy levels of an ion comprising two energy levels with E₀ and E₁. A transition T1 from energy level E₁ to energy level E₀ has a frequency f. For given ions, the energy level structure is known and hence the expected ion frequencies are known from theory.

Ions confined in a trapped ion system can be sensitive to fluctuations in the magnetic field at the ion position. This magnetic field may be produced by the RF control signal. Fluctuations in the oscillating magnetic field due to the RF control signal can result in shifts in the energy level structure of the ion. This results in a frequency shift of the ion frequency different to what is expected from the standard structure.

FIG. 1(b) shows the energy levels of an ion comprising two energy levels E₀ and E₁ as from theoretical predictions. The figure also shows the shifted energy level E′ for E₁ due to the fluctuating magnetic field. The difference between the shifted energy level E′ and energy level E₁ can be given by ΔE=E′−E₁. Therefore, the transition T2 is now between shifted energy level E′ and energy level E₀ which results in a frequency shift of the ion frequency from f₀ to f′.

These frequency shifts of the ion mean that there is a mismatch between theory and a physical implementation of the trapped ion system. This further can result in poorly controlled and uncalibrated system.

When the frequency shift of the ion is due to an oscillating magnetic field, it is also known as an AC Zeeman shift. The magnitude of the frequency shift of the ion is dependent on the value of the single frequency component used for confinement of the ion of the RF control signal and the magnitude of the oscillating current.

In general terms, the AC Zeeman shift of the state |0) due to a coupling to the transition between states |0) and |i) is given by:
(1)

$${Δ}_{ac , 0 - i} = \frac{{Ω}^{2} {f}_{0 - i}}{2 ( {f}_{0 - i}^{2} - {f}_{RF}^{2} )}$$

Where Δ_{ac,0-i} is the amount of AC Zeeman shift on the state |0) due to coupling to state |i), f₀₋ᵢ is the transition frequency between state |0) and state |i), f_{RF} is the frequency of the RF control signal, 22 is the Rabi frequency. In the context of the present disclosure, the Rabi frequency is the strength of the coupling between the state |0) and the state |i). The notation |i) is used to describe the energy states of the ion. The state |i) will have energy Eᵢ.

FIG. 1(c) is a diagram showing the AC Zeeman shift of the state |0> due to coupling to the state |i>.

The total AC Zeeman shift for the state |0) is the sum over all shifts due to couplings to all possible states |i):

$${Δ}_{ac , 0} = {\sum }_{i} \frac{{Ω}^{2} {f}_{0 - i}}{2 ( {f}_{0 - i}^{2} - {f}_{RF}^{2} )} \qquad ( 2 )$$

Where Δ_{ac,0} is the total AC Zeeman shift for the qubit state |0). Similarly, the total AC Zeeman shift for the state |1) is the sum over all shifts due to couplings to all possible transitions:

$${Δ}_{ac , 1} = {\sum }_{i} \frac{{Ω}^{2} {f}_{1 - i}}{2 ( {f}_{1 - i}^{2} - {f}_{RF}^{2} )} \qquad ( 3 )$$

Where Δ_{ac,1} is the total AC Zeeman shift for the state |1) and f₁₋ᵢ is the transition frequency between state |1) and state |i). The frequency shift of the transition between the states |0) and |1) is then the difference between the total AC Zeeman shift for the qubit state |0) and the total AC Zeeman shift for the qubit state |1):

$${Δ}_{AC} = {Δ}_{ac , 0} - {Δ}_{ac , 1} \qquad ( 4 )$$

For quantum computing purposes, the ions used in trapped ion systems may be encoded as qubits. In the context of the present disclosure, a qubit is a unit of information for quantum computing purposes. The qubit is formed by encoding an ion into a pair of energy states, typically labelled |0) and |1). The ion frequency, therefore, may be referred to as a qubit frequency and hence the frequency shift of the ion may also be referred to as a qubit frequency shift, for example Δ_{AC} in eqn 4. The ions in trapped ion systems can be encoded as other units of information for quantum computing. For example, they may be encoded as a qudit.

In quantum computing, a quantum gate or gate is a circuit operation that is performed on one or more qubits. In the context of the present disclosure, a quantum gate is analogous to logic gates used in electronic circuits. The unexpected qubit frequency shifts can lead to errors in the quantum gates known as gate errors. Gate errors are how much the gate operation performed on the one or more qubits differs from the expected operation from theory. Gate errors can occur in a number of ways. For example, the magnitude of current may change as a function of time due to instabilities in the RF voltage which can lead to qubit frequency shifts that change with time. In addition, the magnitude of the current may vary as a function of position in the trap resulting in different qubit frequency shifts at different positions. This leads to varying device performance across the chip, which can add errors to the computation, result in complex calibration routines, and require a significant control overhead to compensate for.

For example, the qubit may be encoded in the metastable level of a ¹³⁷Ba⁺ ion. FIG. 1(d) is plot from an atomic physics simulation for a ¹³⁷Ba⁺ ion which has been encoded as a qubit into two metastable states. A metastable state is an energy state of an atom or ion which is of higher energy than the ground state. A metastable state has a sufficiently long lifetime suitable for quantum computing, for example, D_{5/2} in ¹³⁷Ba⁺. The two metastable states the ¹³⁷Ba⁺ ion has been encoded with is the F=2, mp=−2 and F=3, mp=−2 states. The notation used to describe these states is by the low-field good quantum numbers F and m_{F}, where F is the number for total angular momentum and m_{F} is the projection on the quantisation axis. For brevity, a ¹³⁷Ba⁺ ion encoded as a qubit in these metastable states shall be referred to as ¹³⁷Ba⁺ qubit in the states |F=2, m_{F}=−2> and |F=3, m_{F}=−2>. The atomic physics simulation shown in FIG. 1(d) is of the ¹³⁷Ba⁺ qubit in the states | F=2, mp=−2> and | F=3, m_{F}=−2> in a Paul-type trap which is being confined by a RF control signal comprising a single frequency component which is used for confinement of the barium ion. The plot shows the amount of AC Zeeman shift the ion experiences as a function of the RF control signal frequency. In the context of the present disclosure, the AC Zeeman shift is the frequency shift of the qubit due to a fluctuating magnetic field. FIG. 1(d) shows the sigma polarisation and pi polarisation of the AC Zeeman shift. The polarisation is the polarisation of the magnetic field at the position of the ¹³⁷Ba⁺ ion in the trapped ion system.

FIG. 1(e) is another plot from an atomic physics simulation for another ¹³⁷Ba⁺ ion which has been encoded as a qubit into two metastable states. In this example, the two metastable states this ¹³⁷Ba⁺ ion has been encoded with is the F=2, m_{F}=0 and F=3, m_{F}=0 states. For brevity, a ¹³⁷Ba⁺ ion encoded as a qubit in these metastable states shall be referred to as a ¹³⁷Ba⁺ qubit in the states |F=2, m_{F}=0> and |F=3, m_{F}=0>. The atomic physics simulation shown in FIG. 1(e) is of the ¹³⁷Ba⁺ qubit in the states |F=2, m_{F}=0> and | F=3, m_{F}=0> in a Paul-type trap which is being confined by a RF control signal comprising a single frequency component which is used for confinement of the barium ion. The plot shows the amount of AC Zeeman shift the ion experiences as a function of the RF control signal frequency. FIG. 1(e) shows the sigma polarisation and pi polarisation of the AC Zeeman shift. The polarisation is the polarisation of the magnetic field at the position of the ¹³⁷Ba⁺ ion in the trapped ion system.

The ¹³⁷Ba⁺ qubit in the states |F=2, m_{F}=−2> and |F=3, m_{F}=−2> and the ¹³⁷Ba⁺ qubit in the states |F=2, m_{F}=0> and |F=3, m_{F}=0> were chosen for simulation examples as they are suitable qubits for quantum computing purposes. From FIG. 1(d) and FIG. 1(e), it can be seen that the AC Zeeman shift is non-linear with respect to the RF control signal frequency chosen. Further, spikes in the plots indicates frequencies when the AC Zeeman shift changes sign. In other words, the frequency shift of the ion may be an increase in frequency or a decrease in frequency with respect to the standard frequency structure of the ion.

The frequency shift Δ_{AC} of the ion in a trapped ion system due to the single frequency component of an RF control signal prevents large-scale trapped-ion quantum computers from being developed. As fluctuations in the frequency shift lead to gate errors. It is an objective of the present disclosure to adjust the frequency shift of the ion to reduce gate errors for quantum computing systems. It is also an objective of the present disclosure to provide a controller which adjusts the frequency shift of the ion regardless of its position in the ion trap. It is a further objective of the present disclosure to provide a controller for generating a control signal comprising a plurality of frequency components for quantum computing purposes.

A control signal comprising a plurality of radio frequency components has previously been used for trapping different species of ions. In particular, when these different species have a significant difference in their charge-to-mass ratio. For example, in “Investigation of two-frequency Paul traps for antihydrogen production” by Leefer et al. (2016), confinement of charged particle species with different charge-to-mass ratios using a RF signal with two frequencies was used in a Paul trap for antihydrogen recombination. In another example, in “Two-frequency operation of a Paul trap to optimise confinement of two species of ions” by Foot et al. (2018) an RF signal with two RF frequency components has been used to confine an atomic ion and a charged nanoparticle. In “Economic synthesis and precision spectroscopy of anti-molecular hydrogen ions in Paul trap” by Dehmelt (1995), a Paul trap using a two frequency voltage for confining ions was used for the synthesis and spectroscopy of anti-molecular hydrogen ions.

A control signal comprising a plurality of radio frequency components has also been used in the development of analytical and numerical solutions to the equation of motion of a trapped ion in a trapped ion system. For example, in “Matrix Methods for the Calculation of Stability Diagrams in Quadrupole Mass Spectroscopy” by Konenkov et al. (2002) the stability of ion motion in a periodic quadrupole field for an ion confined using two or more frequencies was explored using matrix mathematical methods.

However, in all of these previous studies, the two frequency components of the RF signal were used only for confinement of the different particle species.

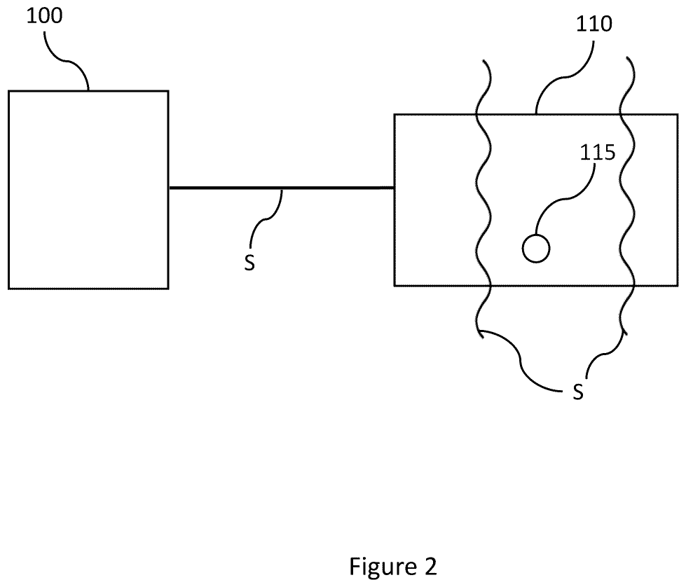

FIG. 2 is an example diagram of a controller 100 for a trapped ion system 110 for confining an ion 115 according to a first embodiment of the present disclosure. The ion 115 may be, for example, a barium ion. In particular, it may be an odd numbered isotope of ion. For example, the ion 115 may be a ¹³⁷Ba⁺ ion. The ion 115 is configured as a unit of information for quantum computing. This unit of information could be, for example, a qubit or a qudit. The trapped ion system 110 may be, for example, a Paul trap. The controller 100 is configured to generate a control signal S.

The control signal S is configured to confine the ion 115 in the trapped ion system 110. The control signal S comprises a plurality of frequency components wherein at least one of the frequency components confines the ion 115 in the trapped ion system 110 and at least one of the frequency components adjusts a frequency shift of the ion 115. The control signal S may be, for example, a radio frequency (RF) control signal and hence the plurality of frequency components may be referred to as a plurality of radio frequency tones. The ion trap system 110 may comprise one or more RF electrodes. In such embodiments, the RF control signal S may be first generated using a standard RF source. The standard RF source may be, for example, a digital synthesizer. The RF control signal S may then be amplified or passed through an RF resonator (not shown), after which the RF control signal S is applied to the RF electrodes. As a result of applying the RF control signal S to the RF electrodes, a confining electric potential is generated at the position of the ion 115 in the trapped ion system 110. The ion 115 is then trapped in the ion trap system 110 when the control signal S is in the oscillating RF field form. At least one of the frequency components of the control signal adjusts the frequency shift of the ion 115 by minimising the frequency shift. The frequency shift may be, for example, an AC Zeeman Shift as a result of an oscillating magnetic field.

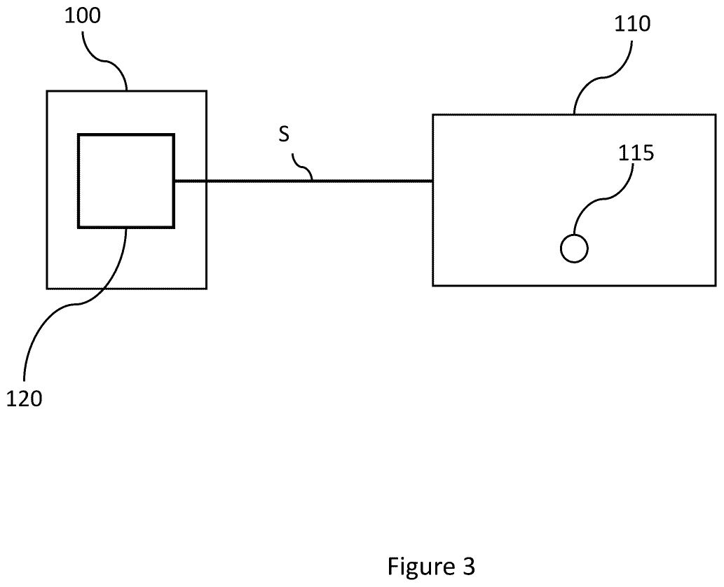

FIG. 3 is another example of a controller 100 for a trapped ion system 110 for confining an ion 115 according to a second embodiment of the present disclosure. The controller 100 is the same as the controller of FIG. 2 except with the addition of a resonator 120. Hence the same labelling has been kept and the components are taken to have the same functionality and meaning as for FIG. 2. The trapped ion system 110 and the ion 115 and the control signal S are the same as for the trapped ion system and ion of FIG. 2, therefore the same labelling has been kept and the components are taken to have the same functionality and meaning as for FIG. 2.

The controller 100 comprises a resonator 120 which is configured to modify the properties of the control signal S. The control signal S may be either a digital signal or an analogue signal. The control signal S comprises a plurality of frequency components wherein at least one of the frequency components confines the ion 115 in the trapped ion system 110 and at least one of the frequency components adjusts a frequency shift of the ion 115. The control signal S may be an RF control signal, hence the resonator 120 may be, for example, a radio frequency resonator such that the resonator 120 is compatible with the RF control signal S. Hence, the plurality of frequency components may be a plurality of radio frequency tones. The plurality of frequency components may adjust the frequency shift of the ion 115 by minimising the frequency shift. The frequency shift may be, for example, an AC Zeeman Shift as a result of an oscillating magnetic field.

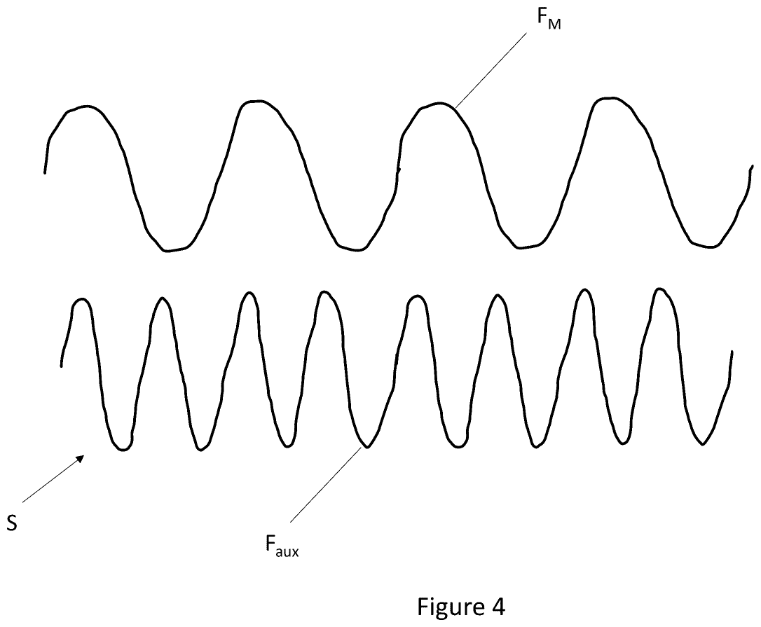

FIG. 4 is an example diagram of a control signal S comprising a plurality of frequency components according to a third embodiment of the present disclosure. The control signal S is the same as the control signal generated by the controller 100 of either FIG. 2 or FIG. 3. Hence the same labelling has been kept and the components are taken to have the same functionality and meaning as for FIG. 2 and FIG. 3.

The plurality of frequency components comprises at least a first frequency F_{M} and a second frequency Fₐᵤₓ, whereby the first frequency F_{M} is configured to confine the ion 115 in the trapped ion system 110 and the second frequency Fₐᵤₓ is configured to adjust the frequency shift of the ion. In some embodiments, the first frequency F_{M} may be lower than the second frequency Fₐᵤₓ. The second frequency component with frequency Fₐᵤₓ comprises a magnitude which can be tuned to adjust for the frequency shift of the ion 115. The second frequency Fₐᵤₓ may adjust the frequency shift of the ion 115 by minimising the frequency shift. The frequency shift may be, for example, an AC Zeeman Shift as a result of an oscillating magnetic field. The control signal S may be, for example, a radio frequency control signal and hence the plurality of frequency components are a plurality of RF tones. Hence, first frequency F_{M} may be referred to as the main tone and the second frequency Fₐᵤₓ may be referred to as the auxiliary tone.

As a worked example, both a ¹³⁷Ba⁺ qubit in the states |F=2, m_{F}=−2> and |F=3, m_{F}=−2> and a ¹³⁷Ba⁺ qubit in the | F=2, m_{F}=0> and |F=3, m_{F}=0> states in the D_{5/2} level have each been simulated in a trapped ion system to illustrate the adjustment in AC Zeeman shift that can be achieved using the controller 100 of the present disclosure. These two qubits have been selected for this worked example as they are suitable for quantum computing purposes. However, other qubits may be used.

Numerical simulations based on Equations (1)-(4) were used to identify pairs of frequency components with suitable strengths to minimise the AC Zeeman shift, as given in Equation (4).

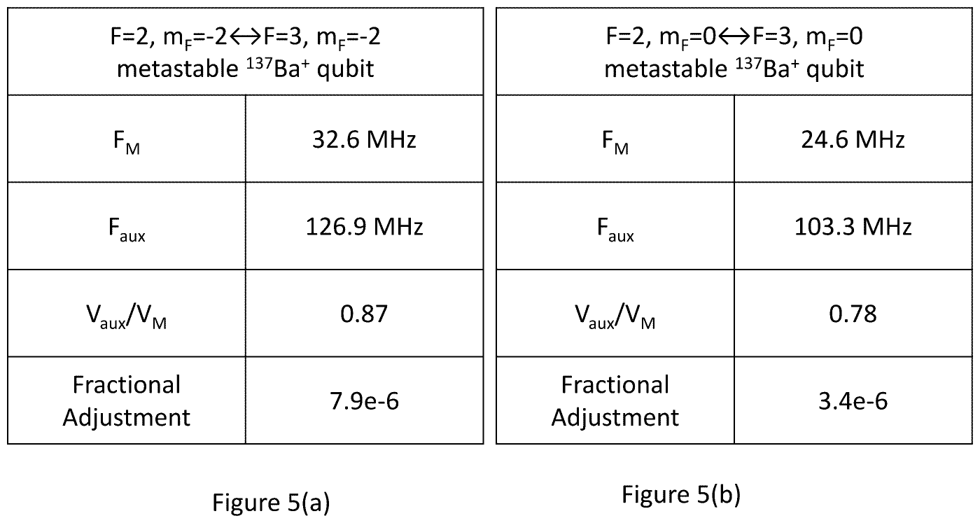

FIG. 5(a) is a table displaying examples of suitable frequency components of a radio frequency control signal for confining a ¹³⁷Ba⁺ qubit in the states | F=2, m_{F}=−2> and |F=3, m_{F}=−2> in a trapped ion system. The radio frequency control signal comprises a first frequency component F_{M} and a second frequency component Fₐᵤₓ. For the ¹³⁷Ba⁺ qubit in the states |F=2, m_{F}=−2> and |F=3, m_{F}=−2>, F_{M} has a value of 32.6 MHz and Fₐᵤₓ has a value of 126.9 MHz. These two radio frequency components of the control signal have a voltage amplitude ratio of: Vₐᵤₓ/V_{M}=0.87. These two frequency components F_{M}, Fₐᵤₓ give a fractional AC Zeeman shift reduction of 7.9e-6. This fractional reduction is found by calculating the ratio of the AC Zeeman shift when using a control signal comprising the two frequency components F_{M}, Fₐᵤₓ to the AC Zeeman shift when using a control signal comprising only the main tone frequency F_{M}.

Therefore, for the ¹³⁷Ba⁺ qubit in the states |F=2, m_{F}=−2> and |F=3, m_{F}=−2> being implemented in a quantum computing system requires an signal generator, such as an arbitrary waveform generator (AWG) coupled to a RF resonator which can support two frequencies, one at 32.6 MHz and another at 126.9 MHz will need to be build. The output of this RF resonator will be connected to an RF electrode. The strength of the second frequency will be set such that Vₐᵤₓ/V_{M}˜0.87 at the trapped ion system.

FIG. 5(b) is a table displaying examples of suitable frequency components of a radio frequency control signal for confining a ¹³⁷Ba⁺ qubit in the states |F=2, m_{F}=0> and |F=3, m_{F}=0> in a trapped ion system. The frequency components F_{M}, Fₐᵤₓ displayed in the table is the combination which provided the greatest reduction in AC Zeeman shift for the qubit. The radio frequency control signal comprises a first frequency component F_{M} and a second frequency component Fₐᵤₓ. For the ¹³⁷Ba⁺ qubit in the states | F=2, m_{F}=0> and |F=3, m_{F}=0>, F_{M} has a value of 24.6 MHz and Fₐᵤₓ has a value of 103.3 MHz. These two radio frequency components of the control signal have a voltage amplitude ratio of: Vₐᵤₓ/V_{M}=0.78. These two frequency components F_{M}, Fₐᵤₓ give a fractional AC Zeeman shift reduction of 3.4e-6. This fractional reduction is found by calculating the ratio of the AC Zeeman shift when using a control signal comprising the two frequency components F_{M}, Fₐᵤₓ to the AC Zeeman shift when using a control signal comprising only the main tone frequency F_{M}.

The robustness of the solutions identified for the two example qubits was also tested. The fractional reduction in AC Zeeman Shift was calculated as a function of fractional current instability of the two RF tones. Current instabilities can occur for a number of reasons. Practically, when implementing the controller 100 of the present disclosure, the amplitudes of the frequency components of the control signal S cannot be set exactly. Further, current instabilities can occur due to the temperature of the trapped ion system changing.

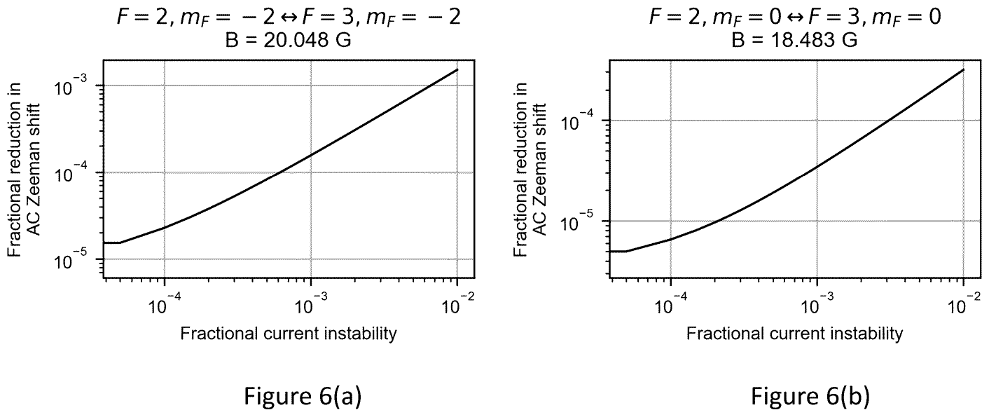

FIG. 6(a) is a plot showing the fractional reduction in AC Zeeman shift as a function of fractional current instability for the ¹³⁷Ba⁺ qubit in the states |F=2, m_{F}=2> and |F=3, m_{F}=2>. The fractional reduction shows the ratio of the AC Zeeman shift using the controller 100 of the present disclosure with F_{M} and Fₐᵤₓ from the table in FIG. 5(a) to the AC Zeeman shift using a single frequency control signal. Looking at the plot, for the lowest fractional current instabilities, the controller 100 of the present disclosure can achieve a reduction of up to 5 orders of magnitude in the AC Zeeman shift. Furthermore, even for fractional current instabilities of approximately 1%, the controller 100 of the present disclosure can still reduce the AC Zeeman shift by ˜3 orders of magnitude.

FIG. 6(b) is a plot showing the fractional reduction in AC Zeeman shift as a function of fractional current instability for the ¹³⁷Ba⁺ qubit in the states |F=2, m_{F}=0> and |F=3, m_{F}=0>. The fractional reduction shows the ratio of the AC Zeeman shift using the controller 100 of the present disclosure with F_{M} and Fₐᵤₓ from the table in FIG. 5(b) to the AC Zeeman shift using a single frequency control signal. Looking at the plot, for the lowest fractional current instabilities, the controller 100 of the present disclosure can achieve a reduction of more than 5 orders of magnitude in the AC Zeeman shift. Furthermore, even for fractional current instabilities of approximately 1%, the controller 100 of the present disclosure can still reduce the AC Zeeman shift by ˜4 orders of magnitude.

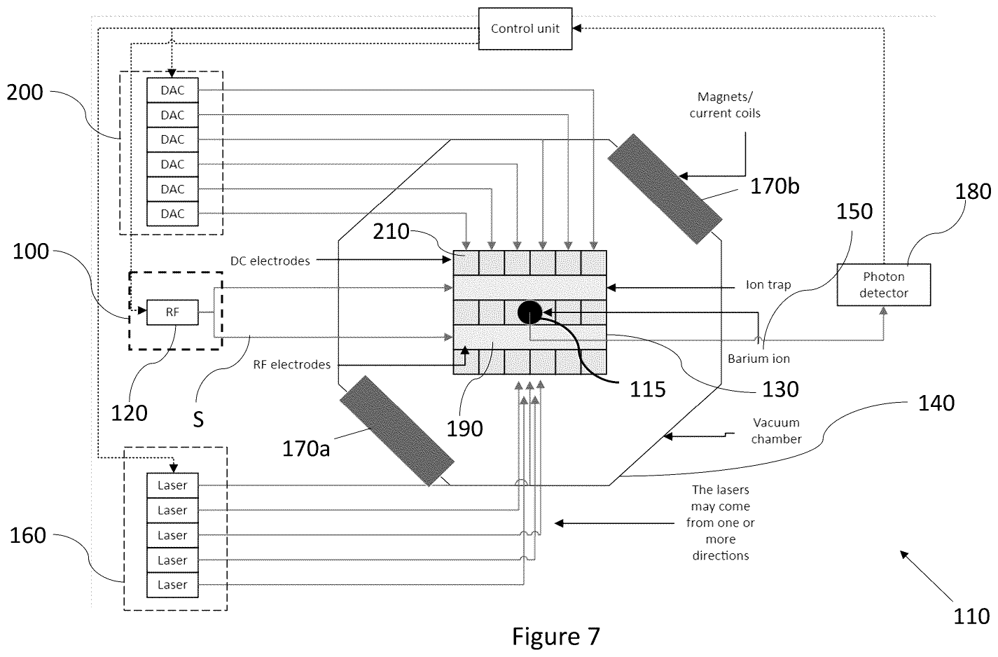

FIG. 7 is an example embodiment of a trapped ion system 110 according to a fourth embodiment of the present disclosure. The trapped ion system 110 could be, for example, a Paul trap. The trapped ion system 110 comprises the controller 100 configured to generate control signal S. The controller comprises a resonator 120.

The controller 100 and the control signal S is the same controller as for FIG. 2 and FIG. 3. Hence the same labelling has been kept and the components are taken to have the same functionality and meaning as for FIG. 2 and FIG. 3. The resonator 120 is the same resonator as for FIG. 3. Hence the same labelling has been kept and the components are taken to have the same functionality and meaning as for FIG. 3.

The trapped ion system 110 may also comprise one or more an ion trap 130; a vacuum chamber 140; an ion source 150; a qubit manipulation system 160; and a magnetic field source 170a, 170b. The trapped ion system 100 may further comprises a fluorescence detector 180, RF electrodes 190, a DC voltage source 200 and DC electrodes 210. The qubit manipulation system 140 may comprise a pair of antennas, not shown in FIG. 7.

The ion trap 130 is configured to trap the barium ion 115 and is situated within the vacuum chamber 140. The ion trap 130 comprises RF electrodes 190 and DC electrodes 210. The RF electrodes 190 are configured to receive control signal S and generate an oscillating voltage or trap RF voltage. The DC electrodes 210 couple the ion trap 130 to the DC voltage source 200 and are configured to generate the static voltage. It will be appreciated that in further embodiments, alternative electrodes and electrode configurations may be used, in accordance with the understanding of the skilled person.

The ion trap 130 is also coupled an ion source 150 which is configured to provide the ion 115 to the ion trap 130. In this example embodiment the ion source 150 is a barium ion source. It will be appreciated that in further embodiments, alternative ion sources may be used, in accordance with the understanding of the skilled person. The ion source 150 comprises a neutral atom source to provide the neutral atom and an ionisation device configured to ionize the atom and hence provide the ion 115. The neutral atom source and ionisation device are not shown in the Figure. The neutral atom source could be, for example, a resistively heated atomic oven or an ablation target. The ionisation device could be, for example, a network of lasers of various operational wavelengths.

The magnetic field source 170a, 170b may be positioned within the vacuum chamber 140 or outside the vacuum chamber 140, and is configured to apply a magnetic field to the ion trap 130.

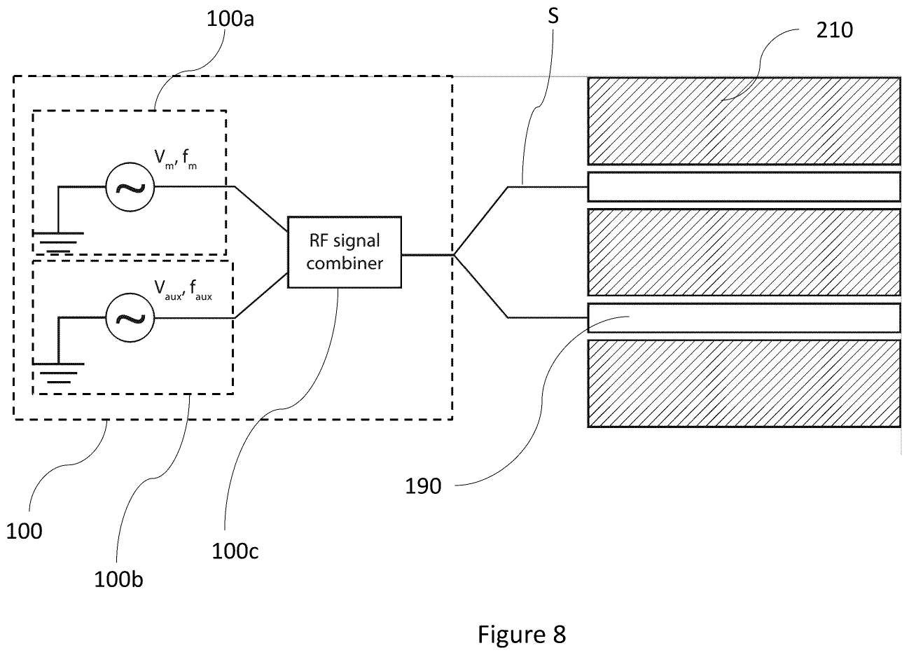

FIG. 8 is an exemplary embodiment of a controller 100 configured to be used with an RF resonator according to a fifth embodiment of the disclosure. The controller 100 is configured to generate the control signal S comprising a first frequency component fₘ and a second frequency component fₐᵤₓ. It is understood that the controller 100 may be adapted to provide an arbitrary number of frequency components according to the knowledge and understanding of the skilled person.

The controller 100 comprises a first voltage source 100a and a second voltage source 100b. The first voltage source 100a is configured to generate the first frequency component fₘ and the second voltage source 100b is configured to generate the second frequency component fₐᵤₓ. The first voltage source 100a and the voltage source 100b may be, for example, digital synthesizers, RF synthesizers and/or arbitrary waveform generators (AWGs). The controller 100 further comprises a signal combiner 100c configured to combine the first frequency component fₘ and the second frequency component fₐᵤₓ into a single control signal S. The signal combiner 100c may be, for example, an RF signal combiner. After the first frequency component fₘ and the second frequency component fₐᵤₓ have been combined into a single control signal S, the control signal may be passed through an RF resonator (not shown). The RF resonator may be used to modify the properties of the control signal S. Afterwards, the control signal S is directed towards the RF electrodes 190.

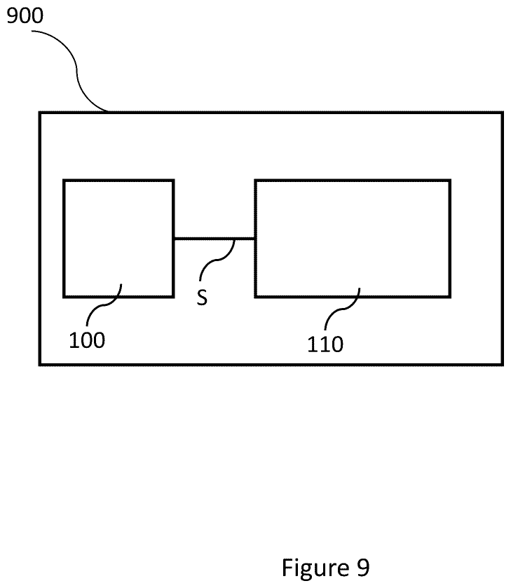

FIG. 9 is a diagram of an apparatus 900 according to a sixth embodiment of the disclosure. The apparatus 900 comprises a trapped ion system 110 for confining an ion and a controller 100 for the trapped ion system 110. The controller 100 can be one of any of the embodiments described in the present disclosure. The controller 100 is configured to generate a control signal S, wherein the control signal S is configured to confine the ion in the trapped ion system 110. The control signal S comprises a plurality of frequency components wherein at least one of the frequency components confines the ion in the trapped ion system 110 and at least one of the frequency components adjusts a frequency shift of the ion.

The apparatus 900 may be, for example, a quantum a computer. Therefore, the ion may be, for example, a unit of information for quantum computing such as a qubit or a qudit.

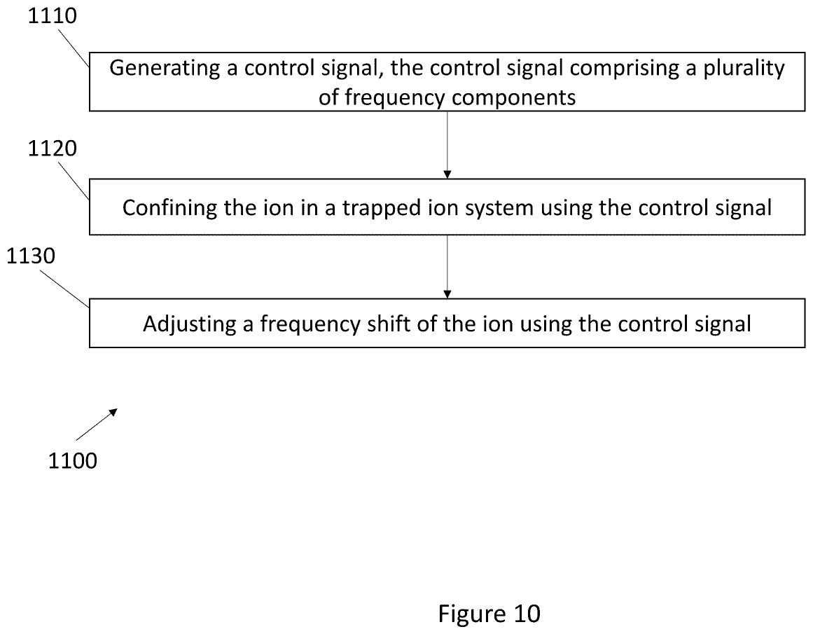

FIG. 10 is a flow chart showing a method of confining an ion in a trapped ion system.

At step 1110, a control signal is generated. The control signal comprises a plurality of frequency components. The control signal is generated using a controller. At step 1120 the ion is confined in the trapped ion system using the control signal. Finally at step 1130, a frequency shift of the ion is adjusted using the control signal. The frequency shift may be, for example, an AC Zeeman shift.

Various improvements and modifications may be made to the above without departing from the scope of the disclosure.

A skilled person will appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A controller for a trapped ion system, the controller configured to:
generate a control signal, the control signal configured to confine an ion in the trapped ion system;
the control signal comprising a plurality of frequency components, wherein at least one of the plurality of frequency components adjusts a frequency shift of the ion.

2. The controller of claim 1, wherein the ion is a barium ion.

3. The controller of claim 1, wherein the ion is configured as a unit of information for quantum computing.

4. The controller of claim 3, wherein the unit of information for quantum computing is a qubit or a qudit.

5. The controller of claim 1, wherein the controller comprises a resonator, configured to modify the control signal.

6. The controller of claim 5, wherein the resonator is a radio frequency resonator such that the control signal modified is a radio frequency control signal.

7. The controller of claim 1, wherein the plurality of frequency components comprise at least a first frequency and a second frequency.

8. The controller of claim 7, wherein the first frequency is configured to confine the ion in the trapped ion system and the second frequency is configured to adjust the frequency shift of the ion.

9. The controller of claim 8, wherein the second frequency comprises a magnitude, the magnitude being tuned to adjust for the frequency shift of the ion.

10. The controller of claim 9, wherein the second frequency adjusts the frequency shift of the ion by minimising the frequency shift of the ion.

11. The controller of claim 10, wherein the frequency shift of the ion is an AC Zeeman shift of the ion.

12. The controller of claim 1, wherein the control signal is a radio frequency control signal and the plurality of frequency components are a plurality of radio frequency tones.

13. The controller of claim 1, wherein the at least one of the plurality of frequency components adjust the frequency shift of the ion by minimising the frequency shift.

14. The controller of claim 13, wherein the frequency shift of the ion is an AC Zeeman shift.

15. The controller of claim 1, wherein the trapped ion system is a Paul trap.

16. An apparatus comprising:
a trapped ion system; and
a controller for the trapped ion system, the controller configured to generate a control signal;
the control signal configured to confine an ion in the trapped ion system, the control signal comprising a plurality of frequency components, wherein at least one of the plurality of frequency components adjusts a frequency shift of the ion.

17. The apparatus of claim 16, wherein the ion is configured as a unit of information for quantum computing.

18. The apparatus of claim 17, wherein the unit of information for quantum computing is a qubit or a qudit.

19. The apparatus of claim 18 wherein the apparatus is a quantum computer.

20. A method of confining an ion in a trapped ion system, the method comprising:
generating, using a controller, a control signal, the control signal configured to confine the ion in the trapped ion system;
the control signal comprising a plurality of frequency components, wherein at least one of the plurality of frequency components adjusts the frequency shift of the ion.
